(19) United States
(12) Patent Application Publication
(10) Pub. No.: US 2005/0008208 A1
(43) Pub. Date: Jan. 13, 2005

(54) Acquisition-time modeling for automated post-processing

(76) Inventors: Brett Cowan, Auckland (NZ); Alistair Young, Ponsonby (NZ); Thomas O'Donnell, New York, NY (US)

Correspondence Address: Siemens Corporation;Intellectual Property Department, 170 Wood Avenue South, Iselin, NJ, 08830, US

(21) Appl. No.: 10/876,101

(22) Filed: Jun. 24, 2004

Related U.S. Application Data
(60) Provisional application No. 60/482,329, filed on Jun. 25, 2003.

(51) Int. Cl. G06K 9/00

(52) U.S. Cl. 382/128

(57) ABSTRACT

A system and method for acquisition-time modeling and automated post-processing are provided, where the system includes a processor, a user interface in signal communication with the processor for receiving preliminary scan data, a modeling unit in signal communication with the processor for fitting a model to the preliminary scan data, an imaging adapter in signal communication with the processor for receiving detailed scan data, and a detection unit in signal communication with the processor for detecting expected features in the detailed scan data; and the method includes receiving preliminary scan data, fitting a model to the preliminary scan data, receiving detailed scan data responsive to the model, and checking for expected features in the detailed scan data.

### CROSS-REFERENCE TO RELATED APPLICATION

This application claims the benefit of U.S. Provisional Application Ser. No. 60/482,329 (Attorney Docket No. 2003P09200US), filed Jun. 25, 2003 and entitled “Acquisition Time Modeling for Automated Post-Processing”, which is incorporated herein by reference in its entirety.

### BACKGROUND

Medical image scanning data, for example, is typically obtained in the form of slices in various types of imaging modalities. These slices are then stacked to form a three-dimensional (“3D”) volume.

In current approaches to medical image scanning, model fitting takes place “post-processing”, that is, after the images are acquired. Thus, knowledge obtained from the model cannot be exploited during the scanning session. Errors such as misregistration may be discovered too late, resulting in an inaccurate analysis or even another trip to the scanner.

Accordingly, what is needed is a system and method capable of acquisition-time modeling for automated post-processing. The present disclosure addresses these and other issues.

### SUMMARY

These and other drawbacks and disadvantages of the prior art are addressed by an apparatus and method of acquisition-time modeling for automated post-processing.

A system for acquisition-time modeling and automated post-processing includes a processor, a user interface in signal communication with the processor for receiving preliminary scan data, a modeling unit in signal communication with the processor for fitting a model to the preliminary scan data, an imaging adapter in signal communication with the processor for receiving detailed scan data, and a detection unit in signal communication with the processor for detecting expected features in the detailed scan data.

A corresponding method for acquisition-time modeling and automated post-processing includes receiving preliminary scan data, fitting a model to the preliminary scan data, receiving detailed scan data responsive to the model, and checking for expected features in the detailed scan data.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches an apparatus and method of acquisition-time modeling for automated post-processing, in accordance with the following exemplary figures, in which:

FIG. 1 shows an apparatus for acquisition-time modeling in accordance with an illustrative embodiment of the present disclosure; and

FIG. 2 shows a flowchart for acquisition-time modeling in accordance with an illustrative embodiment of the present disclosure.

### DETAILED DESCRIPTION OF PREFERRED EMBODIMENTS

In accordance with preferred embodiments of the present disclosure, regions of interest are modeled during a medical image scanning session to adapt the acquisition to the specifics of the patient, thus facilitating more efficient recovery of features. By introducing a model early in the process, tangible benefits are accrued.

In prior approaches to medical image scanning, model fitting took place after the images were acquired. Thus, knowledge obtained from the model could not be exploited during the scanning session. Errors such as misregistration, which are caught easily from a model fit, were typically discovered too late, resulting in an inaccurate analysis or even another trip to the scanner.

By incorporating model fitting into the scanning session, the imaging protocols may be adapted based on information from the model. It then becomes possible for the scanner to focus on specific regions if it is suspected that the patient has an abnormality in those regions. For example, if it is known that the patient is scheduled for Fontans surgery, scans may be acquired based on the model geometry that take into account the characteristics of a Fontans heart.

To model the structures of interest, many approaches may be employed. In a simple method, a clinician may delineate the borders of an object of interest in a few 2D images using a contour drawing tool such as Argus™ by Siemens Medical Solutions. A 3D parametric model may then be fit to this set of 2D contours. The parametric model, in a simple case, could be a 3D ellipsoid with parameters describing the radii in the model-centered x, y and z directions. These parameters are adjusted to minimize the Root Mean Square (“RMS”) error between the contour points and the surface of the model. This minimization may employ gradient decent if the parametric model is in analytic form. In any case, the space of parameter values is searched to find the settings that place the model closest to the data.

Alternatively, the model may be of polygonal form, and may be fit by treating the polygons as forming a spring-node mesh. More specifically, starting with a polygonal model, which resembles a typical instance of the structure of interest, the shape of the model is changed by adjusting the vertices or nodes of the polygons so as to minimize the RMS distance between the delineated contour points and the surface of the model. In order to maintain a smooth model surface, the sides of the polygons act like springs so that when one node or vertex is adjusted, its neighbors are pulled along as well.

In cases where a clinician is not available to manually segment borders, edge detection algorithms may be employed. In this approach, the image is convolved with a filter, such as a Sobel filter, for example, which detects sharp changes in intensity indicating the borders of an object. In fitting a model to these edges, information about the directions of the edges, such as dark to bright and bright to dark transitions, and the like, is useful in distinguishing the appropriate edges from those belonging to other structures. In a manner similar to that used in contour fitting, the model is adjusted to minimize the RMS distance from the model to the closest edge points. For fitting to edges, however, it is preferred that the model start close to the solution so as not to be drawn towards inappropriate edges.

Different modeling techniques may include spherical harmonics as described by Goldgof, for example, Finite Element Methods (“FEM”) as described by Alistair Young, for example, or population modeling as described by Tim Cootes, for example. Once the model is fit it may serve as an atlas. That is, once it is know approximately where the regions of interest lie, the scan planes may be adjusted to acquire them accordingly. For example, once a model of the whole heart is fit to a few scout images, the left ventricle (“LV”), which is generally of great interest to cardiologists, may be localized in space and further detailed scans may be made of this region. Fewer scans could be dedicated to the less interesting regions, such as the Right Atrium (“RA”), for example.

In addition, using the whole heart example, if, once the model is fit, it is discovered that the RA appears defective (i.e., that the image edges do not match well with the model or atlas, or that the atlas had to be deformed in an odd manner, further detailed scans of this region could be made. In the case of structural congenital abnormalities (e.g., patients who might undergo a Fontans surgery) it may be necessary to acquire images that highlight the regional defect. In the case of a ventricular septal abnormality, such as, for example, a hole that connects the chambers, several images of the septum in the plane of the septum might be acquired.

Thus, once the model is fit, automatic detection of areas that merit concentration becomes possible. If, for example, a heart model wall is found to be abnormally thin, extra scans confirming and/or allowing further quantification of this deficiency may be acquired. In addition, scan quality can be assessed in real time, and if the scan is not acceptable because of poor gating or breath-hold, then it can be automatically repeated.

Including a model with the acquisition allows much more time to perform sophisticated and relatively time-consuming image processing after the scanning session or “off-line”, including setting up pre-processed images. Expected features may be checked during this period.

Expected features are structures, boundaries or volumes detected in accordance with the model. In the case of the whole heart, for example, the expected features might include the heart wall or edge of the heart, and a blood pool within the heart. The expected features may also include blood vessels, such as the Aorta, for example.

Thus, in the time it takes to transfer images from the scanner to a nearby workstation, finely tuned segmentation algorithms may be brought to bear using the model as a starting point. The user may start the post-acquisition analysis with a segmented dataset.

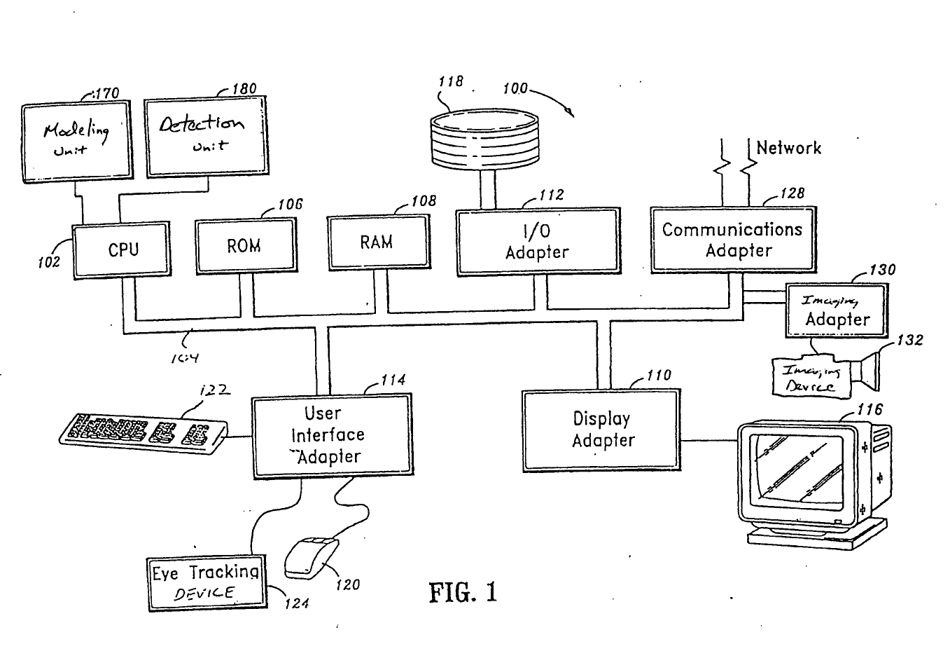

As shown in FIG. 1, a system for acquisition-time modeling and automated post-processing according to an illustrative embodiment of the present disclosure is indicated generally by the reference numeral 100. The system 100 includes at least one processor or central processing unit (“CPU”) 102 in signal communication with a system bus 104. A read only memory (“ROM”) 106, a random access memory (“RAM”) 108, a display adapter 110, an I/O adapter 112, a user interface adapter 114, a communications adapter 128, and an imaging adapter 130 are also in signal communication with the system bus 104. A display unit 116 is in signal communication with the system bus 104 via the display adapter 110. A disk storage unit 118, such as, for example, a magnetic or optical disk storage unit is in signal communication with the system bus 104 via the I/O adapter 112. A mouse 120, a keyboard 122, and an eye tracking device 124 are in signal communication with the system bus 104 via the user interface adapter 114. A magnetic resonance imaging device 132 is in signal communication with the system bus 104 via the imaging adapter 130.

A modeling unit 170 and a detection unit 180 are also included in the system 100 and in signal communication with the CPU 102 and the system bus 104. While the modeling unit 170 and the detection unit 180 are illustrated as coupled to the at least one processor or CPU 102, these components are preferably embodied in computer program code stored in at least one of the memories 106, 108 and 118, wherein the computer program code is executed by the CPU 102. As will be recognized by those of ordinary skill in the pertinent art based on the teachings herein, alternate embodiments are possible, such as, for example, embodying some or all of the computer program code in registers located on the processor chip 102. Given the teachings of the disclosure provided herein, those of ordinary skill in the pertinent art will contemplate various alternate configurations and implementations of the modeling unit 170 and the detection unit 180, as well as the other elements of the system 100, while practicing within the scope and spirit of the present disclosure.

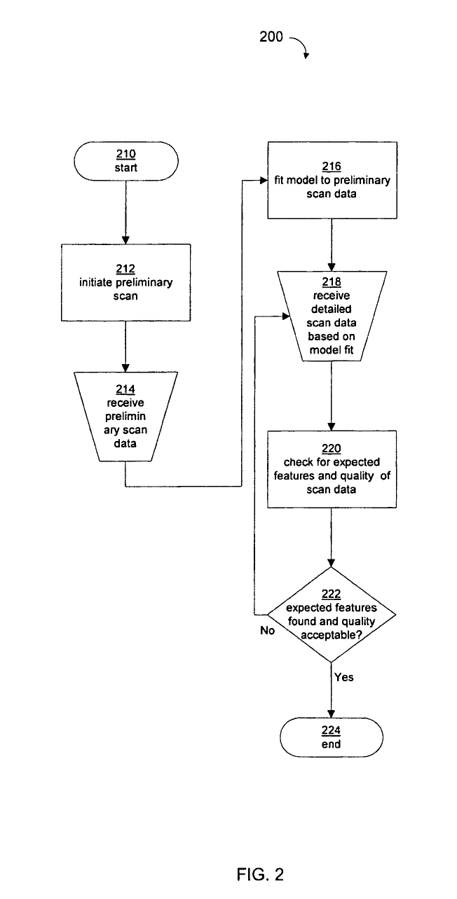

Turning to FIG. 2, a flowchart for acquisition-time modeling and automated post-processing according to an illustrative embodiment of the present disclosure is indicated generally by the reference numeral 200. The flowchart 200 includes a start block 210 that passes control to a function block 212. The function block 212 initiates a preliminary scanning session and passes control to an input block 214. The input block 214 receives preliminary scan data and passes control to a function block 216.

The function block 216 fits a model to the preliminary scan data and passes control to an input block 218. The input block 218 receives detailed scan data based on the model fit and passes control to a function block 220. The function block 220, checks for expected features and quality in the detailed scan, and passes control to a decision block 222. The decision block 222 passes control back to block 218 if the expected features are not detected or the scan quality is unacceptable, but otherwise passes control to an end block 224. These checks serve as a form of quality control to detect mistakes such as misregistration. If problems are detected, control flows back to block 218 where the detailed data is re-scanned.

Thus, embodiments of the present disclosure provide powerful acquisition-time modeling tools for applications in a 3D environment, enabling users to extract significant 3D features and 3D regions-of-interest. Preferred embodiments can serve as very useful 3D acquisition-time modeling and automated post-processing tools in clinical applications.

These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

1. A method (200) of acquisition-time modeling for automated post-processing, the method comprising:
receiving preliminary scan data (214);
fitting a model to the preliminary scan data (216);
receiving detailed scan data responsive to the model (218); and
checking for expected features in the detailed scan data (220).

2. A method as defined in claim 1, further comprising repeating the step of receiving detailed scan data responsive to the model (218).

3. A method as defined in claim 2, further comprising displaying the detailed scan data.

4. A method as defined in claim 3, further comprising checking the scan quality (222).

5. A method as defined in claim 1, further comprising repeating the step of receiving detailed scan data responsive to the model (218) if the checked for expected features in the detailed scan data are insufficient.

6. An apparatus (100) for acquisition-time modeling and automated post-processing, comprising:
preliminary scanning means for receiving preliminary scan data (112, 114, 128, 130);
modeling means for fitting a model to the preliminary scan data (102, 170);
detailed scanning means for receiving detailed scan data responsive to the model (130); and
checking means for checking for expected features in the detailed scan data (102, 180).

7. An apparatus as defined in claim 6, further comprising rescanning means for repeating the step of receiving detailed scan data responsive to the model (102).

8. An apparatus as defined in claim 7, further comprising display means for displaying the detailed scan data (110).

9. An apparatus as defined in claim 8, further comprising quality checking means for checking the scan quality (102, 110, 114).

10. An apparatus as defined in claim 6, further comprising expectation means for repeating the step of receiving detailed scan data responsive to the model (218) if the checked for expected features in the detailed scan data are insufficient (102).

11. A system for acquisition-time modeling and automated post-processing, comprising:
a processor (102);
a user interface (114) in signal communication with the processor for receiving preliminary scan data;
a modeling unit (170) in signal communication with the processor for fitting a model to the preliminary scan data;
an imaging adapter (130) in signal communication with the processor for receiving detailed scan data; and
a detection unit (180) in signal communication with the processor for detecting expected features in the detailed scan data.

12. A system as defined in claim 11 wherein the processor renders the detailed scan data as a 3D image about a region of interest.

13. A system as defined in claim 12, further comprising a display adapter (110) in signal communication with the processor for displaying the rendered 3D image.

14. A system as defined in claim 13 wherein the display adapter and user interface adapter are usable for checking the scan quality.

15. A system as defined in claim 11 wherein the processor changes the model.

16. A program storage device (106, 108, 118, 200) readable by machine, tangibly embodying a program of instructions executable by the machine to perform program steps for acquisition-time modeling and automated post-processing, the program steps comprising:
receiving preliminary scan data (214);
fitting a model to the preliminary scan data (216);
receiving detailed scan data responsive to the model (218); and
checking for expected features in the detailed scan data (220).

17. A program storage device as defined in claim 16, the program steps further comprising repeating the step of receiving detailed scan data responsive to the model (218).

18. A program storage device as defined in claim 17, the program steps further comprising displaying the detailed scan data.

19. A program storage device as defined in claim 18, the program steps further comprising checking the scan quality (222).

20. A program storage device as defined in claim 16, the program steps further comprising repeating the step of receiving detailed scan data responsive to the model (218) if the checked for expected features in the detailed scan data are insufficient.
